(19) United States
(12) Patent Application Publication
(10) Pub. No.: US 2008/0290729 A1
(43) Pub. Date: Nov. 27, 2008

(54) ETHERNET INTERCONNECTION APPARATUS AND METHOD

(76) Inventors: Steve Alan Schoenberg, Clifton Park, NY (US); Michael Jerry O'Connor, Saratoga Springs, NY (US); Jack P. Friedman, Schenectady, NY (US)

Correspondence Address: SCHMEISER, OLSEN & WATTS, 22 CENTURY HILL DRIVE, SUITE 302, LATHAM, NY, 12110, US

(21) Appl. No.: 11/752,971

(22) Filed: May 24, 2007

(51) Int. Cl. H04B 3/54

(52) U.S. Cl. 307/3

(57) ABSTRACT

An Ethernet interconnection device and method. The apparatus includes an input Ethernet connector, a signal separating circuit electrically connected to the input Ethernet connector, a voltage regulator circuit electrically connected to the signal separating circuit, an Ethernet signal repeater circuit electrically connected to the signal separating circuit, and an output Ethernet connector electrically connected to the Ethernet signal repeater circuit. The receiving circuit receives a first voltage signal and an Ethernet data signal from an Ethernet cable. The signal separating circuit separates the first voltage signal from the Ethernet data signal. The voltage regulator conditioning circuit generates a second voltage signal from the first voltage signal. The second voltage signal is a power source the Ethernet signal repeater circuit. The output Ethernet connector is configured to electrically conduct an regenerated Ethernet data signal from the Ethernet signal repeater circuit to an industrial/commercial device.

### FIELD OF THE INVENTION

The present invention relates to an apparatus and associated method for generating a voltage source from power retrieved from an Ethernet cable and using the voltage source to apply power to circuitry internal to an Ethernet interconnection device.

### BACKGROUND OF THE INVENTION

Applying power to various circuits typically requires the use of an apparatus that may be inefficient, costly, and complicated. Accordingly, there exists a need in the art to overcome the deficiencies and limitations described herein above.

### SUMMARY OF THE INVENTION

The present invention provides an Ethernet interconnection device comprising:

an input Ethernet connector configured to interface said Ethernet switch device to an Ethernet cable, wherein said input Ethernet connector is further configured to receive a first power over Ethernet (POE) signal from said Ethernet cable, and wherein said first POE signal comprises a first voltage signal and a first Ethernet data signal;

a signal separating circuit electrically connected to said input Ethernet connector, wherein said signal separating circuit is configured to receive said first POE signal from said input Ethernet connector and separate said first voltage signal from said first Ethernet data signal;

an Ethernet signal repeater circuit electrically connected to said signal separating circuit, wherein said Ethernet signal repeater circuit is configured to receive said first Ethernet data signal from said signal separating circuit and generate a regenerated Ethernet data signal from said first Ethernet data signal;

a voltage regulator circuit electrically connected to said signal separating circuit and said Ethernet signal repeater circuit, wherein said voltage regulator circuit is configured to receive said first voltage signal from said signal separating circuit and generate a second voltage signal from said first voltage signal, wherein said second voltage signal comprises a different voltage from said first voltage signal, and wherein said second voltage signal is a first power source for supplying power for said Ethernet signal repeater circuit; and

a first output Ethernet connector electrically connected to said Ethernet signal repeater circuit, wherein said first output Ethernet connector is configured to electrically conduct said regenerated Ethernet data signal to an industrial/commercial device.

The present invention provides an Ethernet interconnection device comprising:

an input Ethernet connector configured to interface said Ethernet switch device to an Ethernet cable, wherein said input Ethernet connector is further configured to receive a first power over Ethernet (POE) signal from said Ethernet cable, and wherein said first POE signal comprises a first voltage signal and a first Ethernet data signal;

a signal separating circuit electrically connected to said input Ethernet connector, wherein said signal separating circuit is configured to receive said first POE signal from said input Ethernet connector and separate said first voltage signal from said first Ethernet data signal;

an Ethernet switching circuit electrically connected to said signal separating circuit;

a voltage regulator circuit electrically connected to said signal separating circuit and said Ethernet switching circuit, wherein said voltage regulator circuit is configured to receive said first voltage signal from said signal separating circuit and generate a second voltage signal from said first voltage signal, wherein said second voltage signal comprises a different voltage from said first voltage signal, and wherein said second voltage signal is a first power source for supplying power for said Ethernet switching circuit; and

a plurality of output Ethernet connectors electrically connected to said Ethernet switching circuit, wherein said Ethernet switching circuit is configured to receive said first Ethernet data signal from said signal separating circuit and selectively transmit said first Ethernet data signal to each output Ethernet connector of said plurality of output Ethernet connectors, and wherein said plurality of output Ethernet connectors are configured to electrically conduct said first Ethernet data signal to a plurality of industrial/commercial devices.

The present invention provides a method comprising:

receiving, by an Ethernet interconnection device, a first power over Ethernet (POE) signal from an Ethernet cable, said first POE signal comprising a first voltage signal and a first Ethernet data signal, said Ethernet interconnection device comprising an input Ethernet connector connected to a signal separating circuit, a voltage regulator circuit connected to said signal separating circuit, an Ethernet signal repeater circuit connected to said voltage regulator circuit and said signal separating circuit, and output Ethernet connector connected to said Ethernet signal repeater circuit, said Ethernet interconnection device interfaced to said to said Ethernet cable by said input Ethernet connector;

receiving, by said signal separating circuit, said first POE signal from said Ethernet connector;

separating, by said signal separating circuit, said first voltage signal from said first Ethernet data signal;

receiving, by said Ethernet signal repeater circuit, said first Ethernet data signal from said signal separating circuit;

generating, by said Ethernet signal repeater circuit, a regenerated Ethernet data signal from said first Ethernet data signal;

receiving, by said voltage regulator circuit, said first voltage signal from said signal separating circuit; and

generating, by said voltage regulator circuit, a second voltage signal from said first voltage signal, wherein said second voltage signal comprises a different voltage from said first voltage signal, wherein said second voltage signal is a first power source for supplying power for said Ethernet signal repeater circuit, and wherein said first output Ethernet connector is configured to electrically conduct said regenerated Ethernet data signal to an industrial/commercial device.

The present invention provides a method comprising:

receiving, by an Ethernet interconnection device, a first power over Ethernet (POE) signal from an Ethernet cable, said first POE signal comprising a first voltage signal and a first Ethernet data signal, said Ethernet interconnection device comprising an input Ethernet connector connected to a signal separating circuit, a voltage regulator circuit connected to said signal separating circuit, an Ethernet switching circuit connected to said voltage regulator circuit and said signal separating circuit, and a plurality of output Ethernet connectors connected to said Ethernet switching circuit, said Ethernet interconnection device interfaced to said to said Ethernet cable by said input Ethernet connector;

receiving, by said signal separating circuit, said first POE signal from said input Ethernet connector;

separating, by said signal separating circuit, said first voltage signal from said first Ethernet data signal;

receiving, by said Ethernet switching circuit, said first Ethernet data signal from said signal separating circuit;

generating, by said voltage regulator circuit, a second voltage signal from said first voltage signal, wherein said second voltage signal comprises a different voltage from said first voltage signal, and wherein said second voltage signal is a first power source for supplying power for said Ethernet switching circuit; and

selectively transmitting, by said Ethernet switching circuit, said first Ethernet data signal to each output Ethernet connector of said plurality of output Ethernet connectors, wherein said plurality of output Ethernet connectors are configure to electrically conduct said first Ethernet data signal to a plurality of industrial/commercial devices.

The present invention advantageously provides an apparatus and method capable of applying power to various circuits.

### BRIEF DESCRIPTION OF THE DRAWINGS

FIG. 1 illustrates a block diagram of a system comprising an Ethernet interconnection device, in accordance with embodiments of the present invention.

FIG. 2 illustrates a block diagram of a first alternative to the system of FIG. 1, in accordance with embodiments of the present invention.

FIG. 3 illustrates a block diagram of a second alternative to the system of FIG. 1, in accordance with embodiments of the present invention.

FIG. 4 illustrates a block diagram of a first alternative to the system of FIG. 3, in accordance with embodiments of the present invention.

FIG. 5 illustrates a block diagram of a first alternative to the system of FIG. 2, in accordance with embodiments of the present invention.

FIG. 6 illustrates a block diagram of a first alternative to the system of FIG. 5, in accordance with embodiments of the present invention.

FIG. 7 illustrates a block diagram of a third alternative to the system of FIG. 1, in accordance with embodiments of the present invention.

FIG. 8 illustrates a block diagram of a second alternative to the system of FIG. 2, in accordance with embodiments of the present invention.

FIG. 9 illustrates a block diagram of an alternative to the system of FIG. 7, in accordance with embodiments of the present invention.

FIG. 10 illustrates a block diagram of an alternative to the system of FIG. 9, in accordance with embodiments of the present invention.

FIG. 11 illustrates a block diagram of an alternative to the system of FIG. 8, in accordance with embodiments of the present invention.

FIG. 12 illustrates a block diagram of a combination of the systems of FIGS. 7 and 8, in accordance with embodiments of the present invention.

FIG. 13 illustrates a flowchart describing an algorithm used by systems of FIGS. 1-6, in accordance with embodiments of the present invention.

FIG. 14 illustrates a flowchart describing an algorithm used by the systems of FIGS. 6-12, in accordance with embodiments of the present invention.

### DETAILED DESCRIPTION OF THE INVENTION

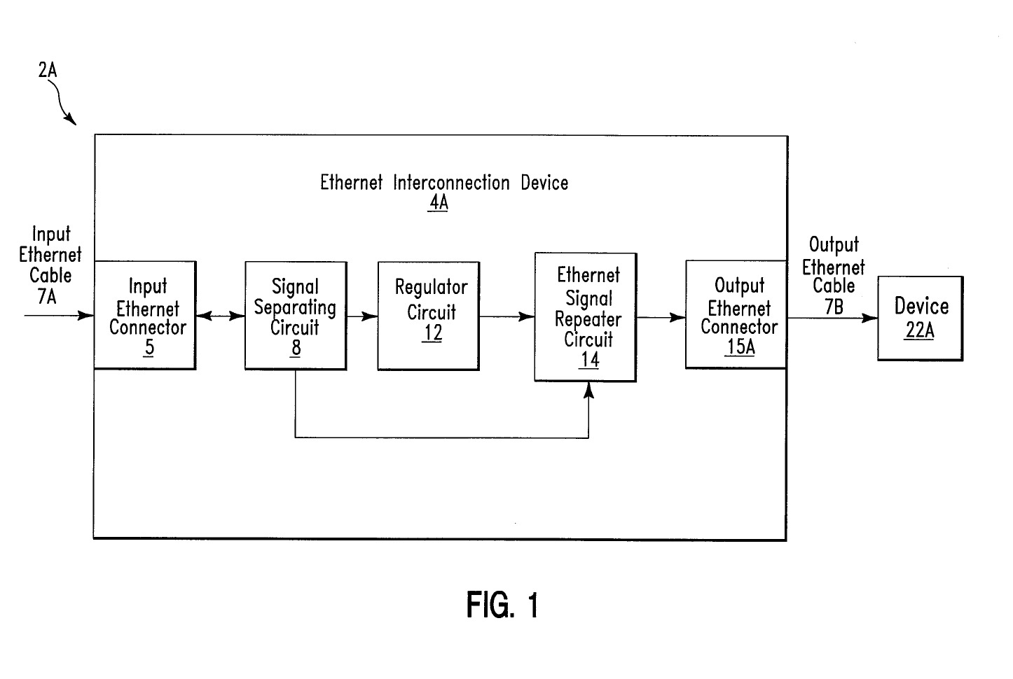

FIG. 1 illustrates a block diagram of a system 2A comprising an Ethernet interconnection device 4A, in accordance with embodiments of the present invention. Ethernet interconnection device 4A may comprise any type of Ethernet interconnection device including, inter alia, an Ethernet repeater, a router, a hub, an Ethernet switch, etc. System 2A comprises Ethernet interconnection device 4A, an input Ethernet cable 7A, an output Ethernet cable 7B, and an industrial/commercial device 22A. Ethernet cable 7A and 7B may comprise any type of Ethernet cable including, inter alia, Category 5 (or higher) cable. Ethernet cable 7A and 7B may comprise conductors of any gauge including, inter alia, 24 gauge, 22 gauge, etc. Ethernet cable 7A is used to retrieve data signals (e.g., I/O signals) and power signals (e.g., power over Ethernet (POE)) from an external apparatus (e.g., a computer). Ethernet cable 7B is used to transmit data signals (e.g., I/O signals) to industrial/commercial device 22A. The power signals supplied by Ethernet cable 7A may be supplied via unused wiring pairs within Ethernet cable 7A (e.g., mid-span sourcing). Alternatively, the power signals supplied by Ethernet cable 7A may be combined with data signals (e.g., endpoint sourcing) on transmit and receive wiring pairs within Ethernet cable 7A. The data signals from Ethernet cable 7A are passed through Ethernet interconnection device 4A and regenerated. The regenerated data signals are transmitted to industrial/commercial device(s) 22A. The data signals are regenerated in order to overcome a distance limitation (i.e., due to Ethernet cable distance related signal strength losses) for transmitting data signals over an Ethernet cable. For example, if a maximum distance (i.e., without signal losses) that a data signal may be transmitted over an Ethernet cable is 100 meters and the signal must be transmitted 170 meters then the signal must be regenerated at 100 meters (i.e., by Ethernet interconnection device 4A) in order to transmit a usable data signal a full 170 meters. Therefore, Ethernet interconnection device 4A is placed in the path of an Ethernet cable in order to regenerate the data signal and extend the distance the Ethernet cable may be run by an additional 100 Meters. Industrial/commercial device(s) 22A may comprise any type of I/O device that is used in a controls/data acquisition environment. For example, industrial/commercial device(s) 22A may comprise, inter alia, industrial instrumentation (e.g., a fieldbus sensor, a transducer, a motor, an actuator, a switch, flow controller, etc), monitoring equipment, a control apparatus (e.g., a programmable logic controller (PLC)), another Ethernet interconnection device, etc. Additionally, industrial/commercial device(s) 22 may comprise any combination of the aforementioned industrial/commercial devices. Ethernet interconnection device 4A is used to retrieve a power over Ethernet (POE) signal comprising a data signal and a first power signal(s) (e.g., a voltage signal) from Ethernet cable 7A and condition the first power signal into a regulated voltage signal (i.e., an output voltage signal) suitable for powering or supplying power for internal circuitry within Ethernet interconnection device 4A and industrial/commercial device(s) 22A. The first power signal supplied through Ethernet cable 7 may be in compliance with the IEEE 802.3af standard.

Ethernet interconnection device 4A comprises an input Ethernet connector 5, a signal separating circuit 8 connected to input Ethernet connector 5, a regulator circuit 12 connected to signal separating circuit 8, an Ethernet signal repeater circuit 14 connected to regulator circuit 12 and signal separating circuit 8, and an output Ethernet connector 15A connected to Ethernet signal repeater circuit 14. Input Ethernet connector 5 is used to interface Ethernet cable 7 to Ethernet interconnection device 4A. Input Ethernet connector 5 may comprise any type of Ethernet connector including, inter alia, an RJ45 connector, an M12 style connector, a Woodhead RJLyxx connector, an Amphenol RJField connector, etc. Data signals (e.g., I/O signals) and power signals retrieved from Ethernet cable 7 are transmitted through Ethernet connector 5 to signal separating circuit 8. Signal separating circuit 8 separates the power signal from the data signal. The data signal is transmitted from signal separating circuit 8 to Ethernet signal repeater circuit 14. The power signal is transmitted from signal separating circuit 8 to regulator circuit 12. Regulator circuit 12 conditions the power signal into a regulated output voltage signal capable of powering or supplying power for Ethernet signal repeater circuit 14 (i.e., Ethernet signal repeater circuit 14 does not require any external power source for power). The power signal is regulated to a desired voltage level. Regulator circuit 12 may comprise current limiting circuitry in order to provide over voltage protection and short circuit protection for Ethernet signal repeater circuit 14. Regulator circuit 12 may be designed to regulate the power signal retrieved from Ethernet cable 7A into a standard voltage signal for use in powering internal circuitry of Ethernet interconnection device 4A. Alternatively, regulator circuit 12 may comprise a circuit for varying a value of the regulated output voltage signal. Upon receiving the regulated output voltage signal from regulator circuit 12, Ethernet signal repeater circuit 14 amplifies or regenerates the data signal from signal separating circuit 8 and the regenerated data signals are transmitted to industrial/commercial device(s) 22A. The data signals are regenerated in order to overcome a distance limitation (i.e., due to signal strength losses) for transmitting data signals over an Ethernet cable. The regenerated data signals are transmitted through output Ethernet connector 15A to industrial/commercial device(s) 22A. The regenerated data signals may be used to control industrial/commercial device(s) 22A, make a request for data from industrial/commercial device(s) 22A, etc.

Ethernet interconnection device 4A may comprise any type of enclosure for protecting the internal circuitry (e.g., signal separating circuit 8, regulator circuit 12, Ethernet signal repeater circuit 14, etc). The enclosure may comprise a rugged material or combination of materials for protecting the internal circuitry from weather related elements (e.g., rain, snow, etc) if used outdoors, industrial elements (e.g., water, dust, electrical surges, etc) if used in an industrial environment, etc. For example, the enclosure may comprise a plastic inner layer covered by a rubber outer layer.

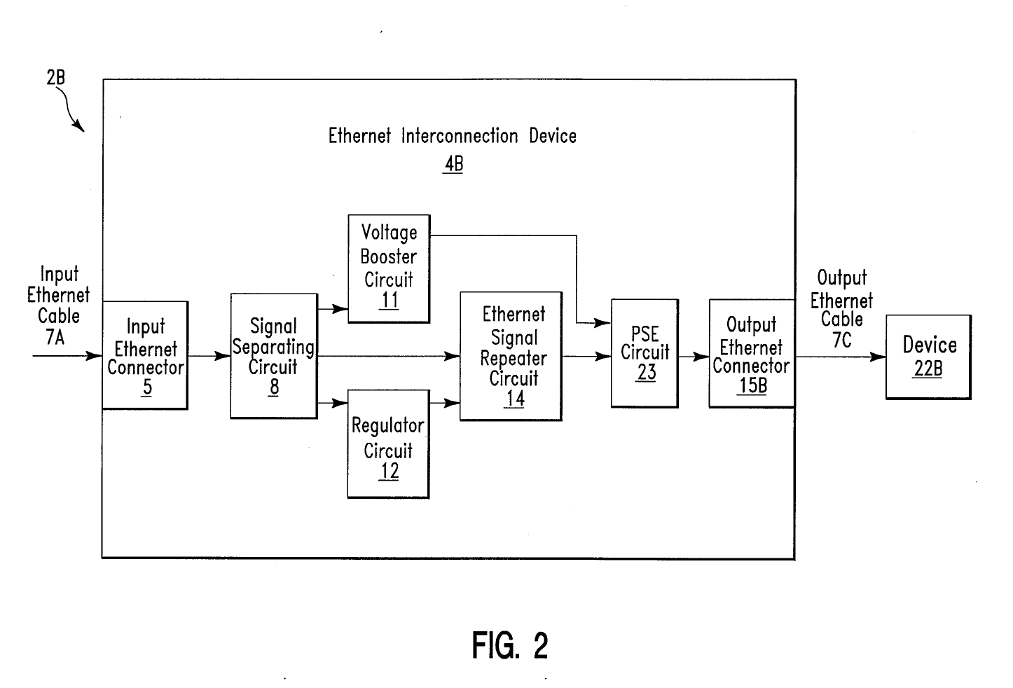

FIG. 2 illustrates a block diagram of a system 2B, in accordance with embodiments of the present invention. System 2B of FIG. 2 comprises a first alternative to system 2A of FIG. 1. In contrast with Ethernet interconnection device 4A of FIG. 1, Ethernet interconnection device 4B of FIG. 2 comprises a voltage boosting circuit 11 (e.g., a DC/DC converter) and a power source equipment (PSE) circuit 23. In contrast with system 2A of FIG. 1, system 2B of FIG. 2 comprises Ethernet cable 7C and industrial/commercial device 22B. Industrial/commercial device 22B of FIG. 2 comprises a POE version of industrial/commercial device 22A of FIG. 1. Ethernet cable 7C is used to transmit data signals and power signals (i.e., POE signals) to industrial/commercial device 22B. Voltage booster circuit 11 retrieves the power signal from signal separating circuit 8 and generates a boosted power signal (i.e., a higher voltage signal from the power signal from signal separating circuit 8) that may comprise a standard voltage signal for use in industrial or commercial systems (e.g., 12 VDC, 24 VDC, etc). The boosted power signal is capable of powering industrial/commercial device 22B. PSE circuit 23 retrieves the regenerated Ethernet data signal from Ethernet signal repeater circuit 14 and the boosted power signal from voltage boosting circuit 11 and combines the aforementioned signals into a POE signal. The POE signal is transmitted through output Ethernet connector 15B to industrial/commercial device 22B. The POE signal is used to apply power and an I/O signal to industrial/commercial device 22B.

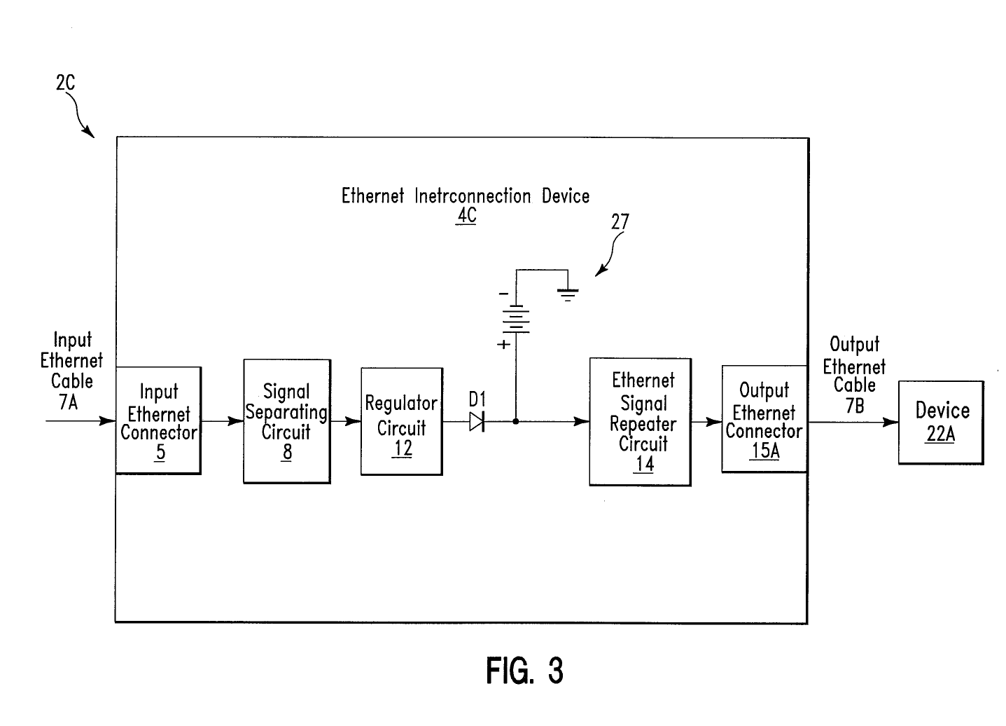

FIG. 3 illustrates a block diagram of a system 2C, in accordance with embodiments of the present invention. System 2C of FIG. 3 comprises a second alternative to system 2A of FIG. 1. In contrast with Ethernet interconnection device 4A of FIG. 1, Ethernet interconnection device 4C of FIG. 3 comprises a diode D1 (e.g., a voltage directing circuit) and a battery 27 (e.g., an electrical voltage storage device). Alternatively, Battery 27 may comprise any type of electrical voltage storage device including, inter alia, a capacitor. Battery 27 may comprise any type of rechargeable battery including, inter alia, lead acid, nickel metal hydride (NiMH), Alkaline, lithium ion, etc. In addition to conditioning a power signal (i.e., from Ethernet cable 7A) into a regulated voltage output signal for supplying power to Ethernet signal repeater circuit 14, the regulated voltage output signal from regulator circuit 12 maintains or provides a charge for battery 27. Charged battery 27 in combination with the regulated voltage output signal from regulator circuit 12 forms an uninterruptible power source (UPS) that will continue to supply power (i.e., voltage) to Ethernet signal repeater circuit 14 if the power signal from Ethernet cable 7A is disabled. In the aforementioned scenario, battery 27 would continue to supply power to Ethernet signal repeater circuit 14. For example, battery 27 may comprise a lead acid type of battery that may be charged by applying a fixed regulated voltage of 14.1 VDC (i.e., from regulator/conditioning circuit 12). As battery 27 charges, a voltage on battery 27 floats up towards the fixed regulated voltage (i.e., 14.1 VDC) while reducing a current flow into battery 27. In this example, a charge rate for battery 27 is regulated to prevent overcharging and damage to battery 27. Diode D1 prevents a back flow of electrical current from battery 27 to regulator circuit 12 thereby preventing damage to regulator circuit 12. Battery 27 may be internal to Ethernet interconnection device 4C (i.e., part of and within Ethernet interconnection device 4C as illustrated in FIG. 3) or external to Ethernet interconnection device 4C.

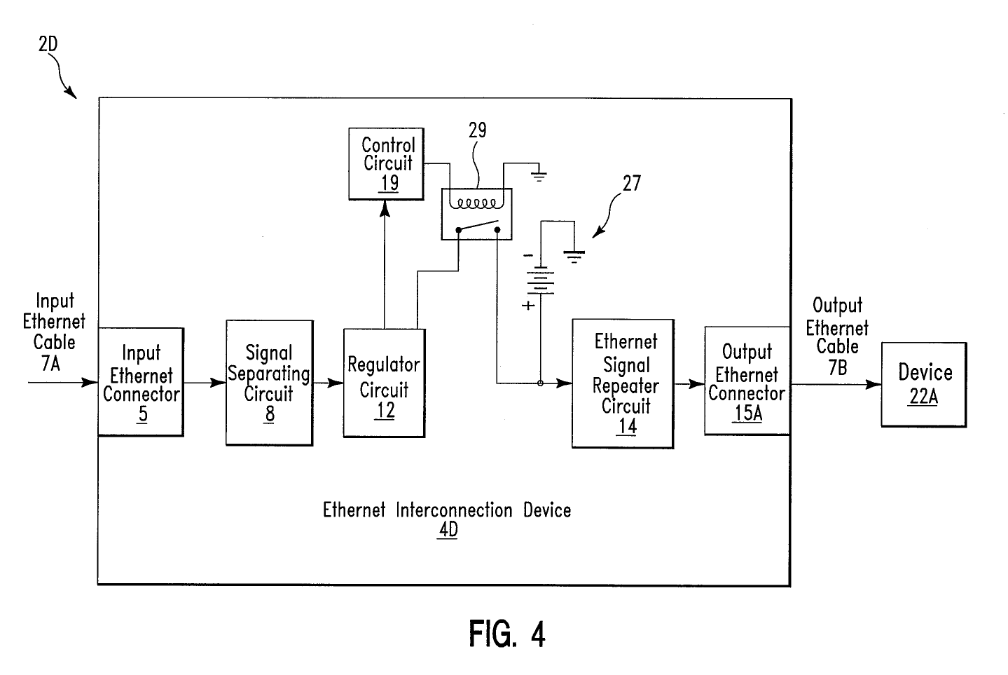

FIG. 4 illustrates a block diagram of a system 2D, in accordance with embodiments of the present invention. System 2D of FIG. 4 comprises a first alternative to system 2C of FIG. 3. In contrast with Ethernet interconnection device 4C of FIG. 3, Ethernet interconnection device 4D of FIG. 4 comprises a normally closed interconnection device 29 (i.e., in place of diode D1) and a control circuit 19. Interconnection device 29 and control circuit 19 (i.e., in combination) of FIG. 4 replace and perform the functions of diode D1 of FIG. 3 (i.e., preventing a backflow of current from battery 27 to regulator circuit 12). Interconnection device 29 may comprise any type of interconnection device including, inter alia, a relay, etc. If control circuit 27 senses that regulator/conditioning circuit 12 is not providing an output voltage signal, control circuit 19 generates a control signal and transmits the control signal to interconnection device 29. In response, interconnection device 29 disables a circuit path between regulator circuit 12 and battery 17 thereby preventing a back flow of voltage from battery 27 to regulator circuit 12. Alternatively, system 2D of FIG. 4 may comprise battery 27 external to Ethernet interconnection device 4D.

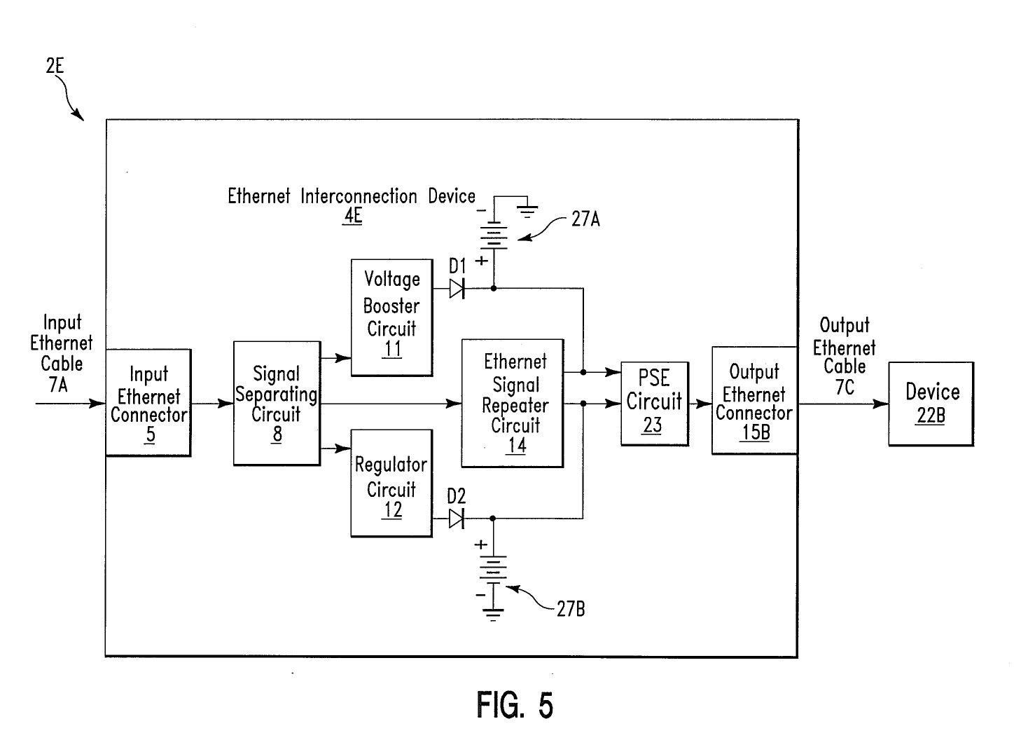

FIG. 5 illustrates a block diagram of a system 2E, in accordance with embodiments of the present invention. System 2E of FIG. 5 comprises a first alternative to system 2B of FIG. 2. In contrast with Ethernet interconnection device 4B of FIG. 2, Ethernet interconnection device 4E of FIG. 5 comprises a diode D1 (e.g., a voltage directing circuit), a diode D2, a battery 27A (e.g., an electrical voltage storage device), and a battery 27B. Alternatively, Battery 27A and 27B may comprise any type of electrical voltage storage device including, inter alia, a capacitor. Battery 27A and 27B may comprise any type of rechargeable battery including, inter alia, lead acid, nickel metal hydride (NiMH), Alkaline, lithium ion, etc. In addition to conditioning a power signal (i.e., from Ethernet cable 7A) into a regulated voltage output signal for supplying power to Ethernet signal repeater circuit 14, the regulated voltage output signal from regulator circuit 12 maintains or provides a charge for battery 27A. Charged battery 27A in combination with the regulated voltage output signal from regulator circuit 12 forms an uninterruptible power source (UPS) that will continue to supply power (i.e., voltage) to Ethernet signal repeater circuit 14 if the power signal from Ethernet cable 7A is disabled. In the aforementioned scenario, battery 27 would continue to supply power to Ethernet signal repeater circuit 14. For example, battery 27A may comprise a lead acid type of battery that may be charged by applying a fixed regulated voltage of 14.1 VDC (i.e., from regulator circuit 12). As battery 27A charges, a voltage on battery 27A floats up towards the fixed regulated voltage (i.e., 14.1 VDC) while reducing a current flow into battery 27A. In this example, a charge rate for battery 27A is regulated to prevent overcharging and damage to battery 27A. Diode D1 prevents a back flow of electrical current from battery 27A to regulator circuit 12 thereby preventing damage to regulator circuit 12. Battery 27A may be internal to Ethernet interconnection device 4E (i.e., part of and within Ethernet interconnection device 4E as illustrated in FIG. 5 or external to Ethernet interconnection device 4E. In addition to boosting a power signal from Ethernet cable 7A into boosted power signal (i.e., a higher voltage signal from the power signal from signal separating circuit 8) capable of powering industrial/commercial device 22B, voltage booster circuit 11 additionally maintains or provides a charge for battery 27B. Charged battery 27B in combination with the boosted power signal from voltage booster circuit 11 forms an uninterruptible power source (UPS) that will continue to supply power (i.e., voltage) to PSE circuit 23 and ultimately to industrial/commercial device 22B if the power signal from Ethernet cable 7A is disabled. In the aforementioned scenario, battery 27B would continue to supply power to PSE circuit 23 and industrial/commercial device 22B. For example, battery 27B may comprise a lead acid type of battery that may be charged by applying a fixed regulated voltage of 14.1 VDC (i.e., from regulator circuit 12). As battery 27B charges, a voltage on battery 27B floats up towards the fixed regulated voltage (i.e., 14.1 VDC) while reducing a current flow into battery 27B. In this example, a charge rate for battery 27B is regulated to prevent overcharging and damage to battery 27B. Diode D2 prevents a back flow of electrical current from battery 27B to voltage booster circuit 12 thereby preventing damage to voltage booster circuit 12. Battery 27B may be internal to Ethernet interconnection device 4E (i.e., part of and within Ethernet interconnection device 4E as illustrated in FIG. 5) or external to Ethernet interconnection device 4E.

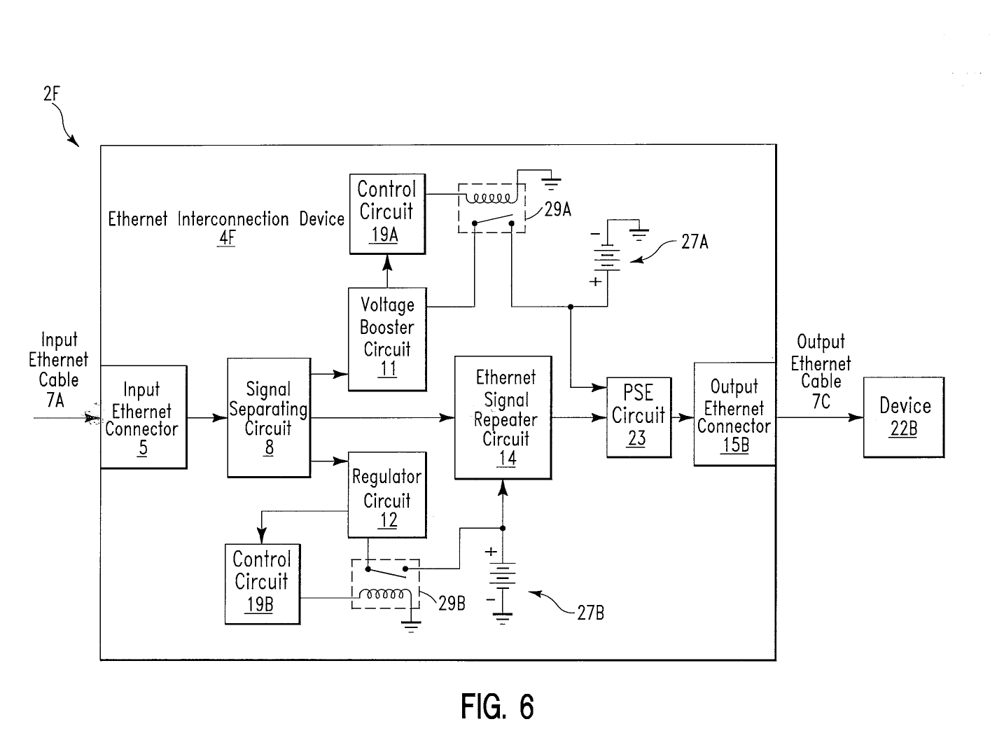

FIG. 6 illustrates a block diagram of a system 2F, in accordance with embodiments of the present invention. System 2F of FIG. 6 comprises a first alternative to system 2E of FIG. 5. In contrast with Ethernet interconnection device 4E of FIG. 5, Ethernet interconnection device 4F of FIG. 6 comprises a normally closed interconnection device 29A (i.e., in place of diode D1), a control circuit 19a, a normally closed interconnection device 29B (i.e., in place of diode D2), and a control circuit 19b. Interconnection device 29A and control circuit 19a (i.e., in combination) of FIG. 6 replace and perform the functions of diode D1 of FIG. 5 (i.e., preventing a backflow of current from battery 27A to voltage booster circuit 11). Interconnection device 29a may comprise any type of interconnection device including, inter alia, a relay, etc. If control circuit 27a senses that voltage booster circuit 11 is not providing an output voltage signal, control circuit 19a generates a control signal and transmits the control signal to interconnection device 29a. In response, interconnection device 29a disables a circuit path between voltage booster circuit 11 and battery 27a thereby preventing a back flow of voltage from battery 27a to voltage booster circuit 11. Interconnection device 29B and control circuit 19b (i.e., in combination) of FIG. 6 replace and perform the functions of diode D2 of FIG. 5 (i.e., preventing a backflow of current from battery 27B to regulator circuit 12). Interconnection device 29b may comprise any type of interconnection device including, inter alia, a relay, etc. If control circuit 27b senses that regulator circuit 12 is not providing an output voltage signal, control circuit 19b generates a control signal and transmits the control signal to interconnection device 29B. In response, interconnection device 29B disables a circuit path between regulator circuit 12 and battery 27B thereby preventing a back flow of voltage from battery 27B to regulator circuit 12.

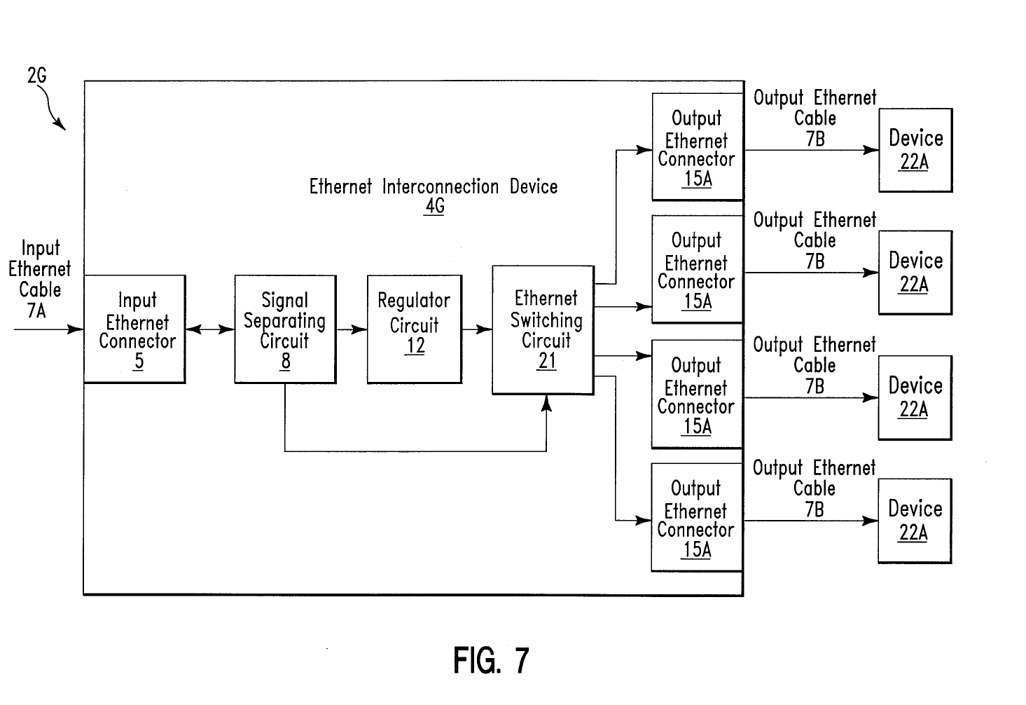

FIG. 7 illustrates a block diagram of a system 2G, in accordance with embodiments of the present invention. System 2G of FIG. 7 comprises a third alternative to system 2A of FIG. 1. In contrast with Ethernet interconnection device 4A of FIG. 1, Ethernet interconnection device 4G of FIG. 7 comprises an Ethernet switching circuit 21 replacing Ethernet signal repeater circuit 14 (i.e., of Ethernet interconnection device 4A of FIG. 1) and a plurality of output Ethernet connectors 15A. In contrast with system 2A of FIG. 1, system 2G of FIG. 7 comprises a plurality of Ethernet cables 7B and a plurality of industrial/commercial devices 22B. Ethernet interconnection device 4G is used to retrieve a power over Ethernet (POE) signal comprising a data signal and a first power signal(s) (e.g., a voltage signal) from Ethernet cable 7A and condition the first power signal into a regulated voltage signal (i.e., an output operating voltage signal) suitable for powering or supplying power for Ethernet switching circuit 21. Ethernet switching circuit 21 is used to retrieve the data signal from signal separating circuit 8 and selectively transmit the data signal though at least one of the plurality of Ethernet connectors 15A to at least one of devices 22A. Upon receiving the regulated output voltage signal from regulator circuit 12, Ethernet switching circuit 21 selectively transmits the data signal though at least one Ethernet connector 15A to at least one associated device 22A.

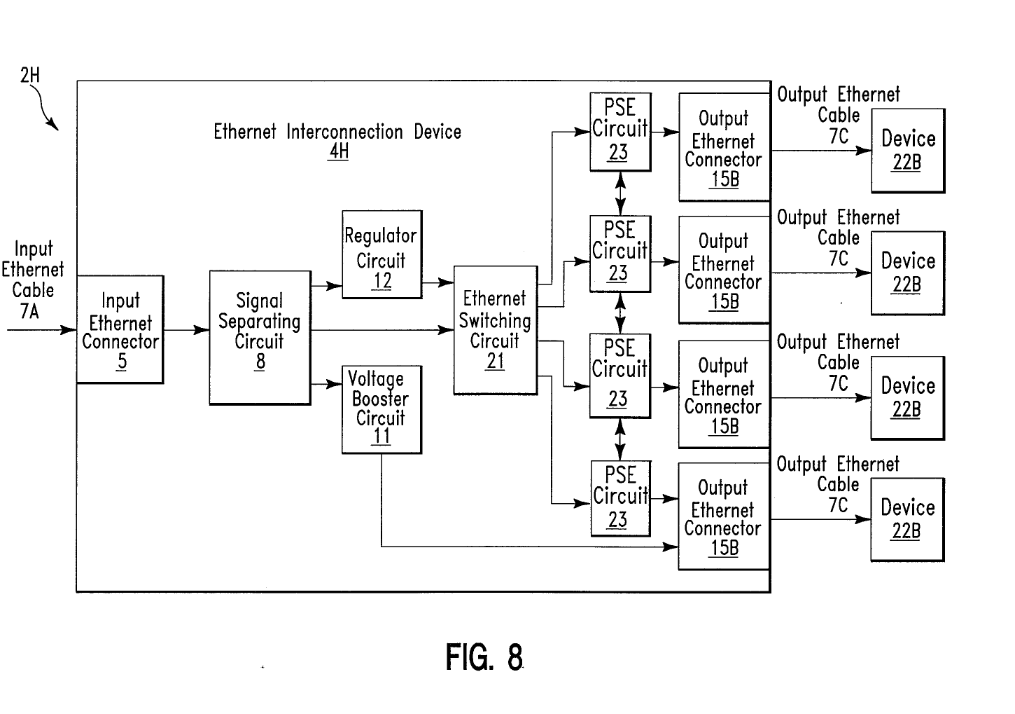

FIG. 8 illustrates a block diagram of a system 2H, in accordance with embodiments of the present invention. System 2H of FIG. 8 comprises a second alternative to system 2B of FIG. 2. In contrast with Ethernet interconnection device 4B of FIG. 2, Ethernet interconnection device 4H of FIG. 8 comprises an Ethernet switching circuit 21 replacing Ethernet signal repeater circuit 14 (i.e., of Ethernet interconnection device 4B of FIG. 2), a voltage booster circuit 11, a plurality of PSE circuits 23, and a plurality of output Ethernet connectors 15B. In contrast with system 2B of FIG. 2, system 2H of FIG. 8 comprises a plurality of Ethernet cables 7C and a plurality of industrial/commercial devices 22B. Ethernet interconnection device 4H is used to retrieve a power over Ethernet (POE) signal comprising a data signal and a first power signal(s) (e.g., a voltage signal) from Ethernet cable 7A and condition the first power signal into regulated voltage signals (i.e., output operating voltage signals) suitable for powering or supplying power for Ethernet switching circuit 21 and industrial/commercial devices 22B. Ethernet switching circuit 21 is used to retrieve the data signal from signal separating circuit 8 and selectively transmit the data signal to at least one of PSE circuits 23. Regulator circuit 12 retrieves the first power signal from signal separating circuit 8 and generates a regulated output voltage signal for powering Ethernet switching circuit 21. Voltage booster circuit 11 retrieves the first power signal from signal separating circuit 8 and generates a boosted power signal (i.e., a higher voltage signal from the first power signal from signal separating circuit 8) that may comprise a standard voltage signal for use in industrial or commercial systems (e.g., 12 VDC, 24 VDC, etc). The boosted power signal is capable of powering each of industrial/commercial devices 22B. Upon receiving the regulated output voltage signal from regulator circuit 12, Ethernet switching circuit 21 selectively transmits the data signal to at least one of PSE circuits 23. The at least one PSE circuit 23 retrieves the boosted power signal from voltage boosting circuit 11 and combines the data signal and the boosted power signal a POE signal(s). The POE signal(s) is transmitted through an associated output Ethernet connector 15B to an associated industrial/commercial device 22B. The POE signal(s) is used to apply power and an I/O signal to an associated industrial/commercial device 22B.

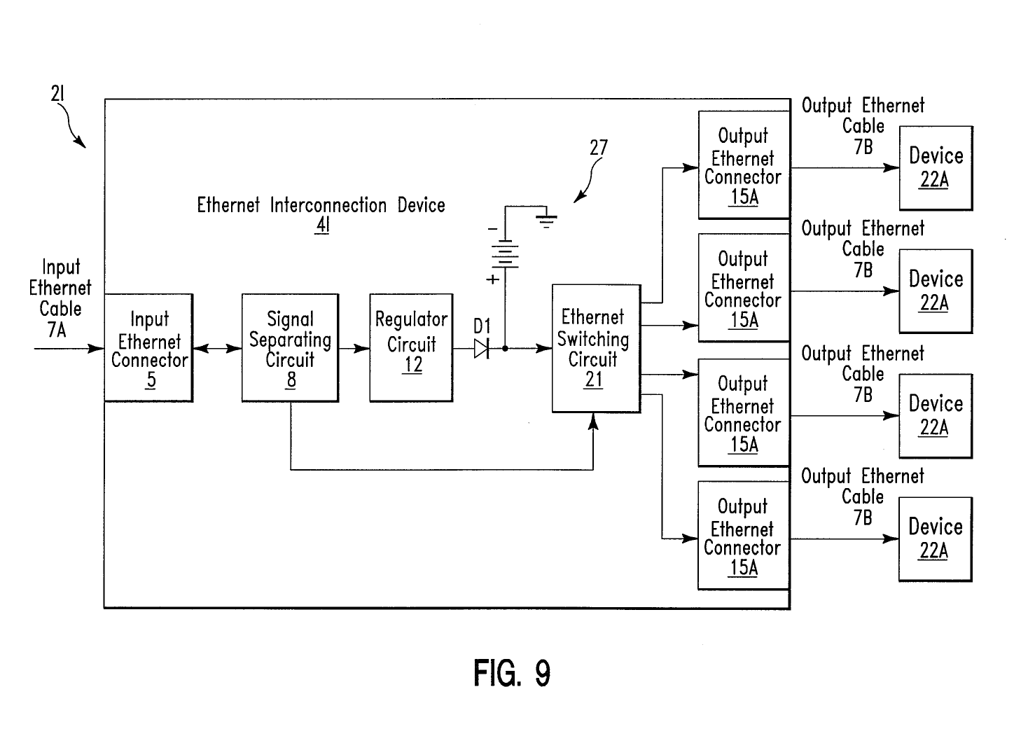

FIG. 9 illustrates a block diagram of a system 21, in accordance with embodiments of the present invention. System 21 of FIG. 9 comprises an alternative to system 2G of FIG. 7. In contrast with Ethernet interconnection device 4G of FIG. 1, Ethernet interconnection device 4I of FIG. 9 comprises a diode D1 (e.g., a voltage directing circuit) and a battery 27 (e.g., an electrical voltage storage device). Alternatively, Battery 27 may comprise any type of electrical voltage storage device including, inter alia, a capacitor. Battery 27 may comprise any type of rechargeable battery including, inter alia, lead acid, nickel metal hydride (NiMH), Alkaline, lithium ion, etc. In addition to conditioning a power signal (i.e., from Ethernet cable 7A) into a regulated voltage output signal for supplying power to Ethernet switching circuit 21, the regulated voltage output signal from regulator circuit 12 maintains or provides a charge for battery 27. Charged battery 27 in combination with the regulated voltage output signal from regulator circuit 12 forms an uninterruptible power source (UPS) that will continue to supply power (i.e., voltage) to Ethernet switching circuit 21 if the power signal from Ethernet cable 7A is disabled. In the aforementioned scenario, battery 27 would continue to supply power to Ethernet switching circuit 21. For example, battery 27 may comprise a lead acid type of battery that may be charged by applying a fixed regulated voltage of 14.1 VDC (i.e., from regulator/conditioning circuit 12). As battery 27 charges, a voltage on battery 27 floats up towards the fixed regulated voltage (i.e., 14.1 VDC) while reducing a current flow into battery 27. In this example, a charge rate for battery 27 is regulated to prevent overcharging and damage to battery 27. Diode D1 prevents a back flow of electrical current from battery 27 to regulator circuit 12 thereby preventing damage to regulator circuit 12. Battery 27 may be internal to Ethernet interconnection device 41 (i.e., part of and within Ethernet interconnection device 4I as illustrated in FIG. 9) or external to Ethernet interconnection device 4I.

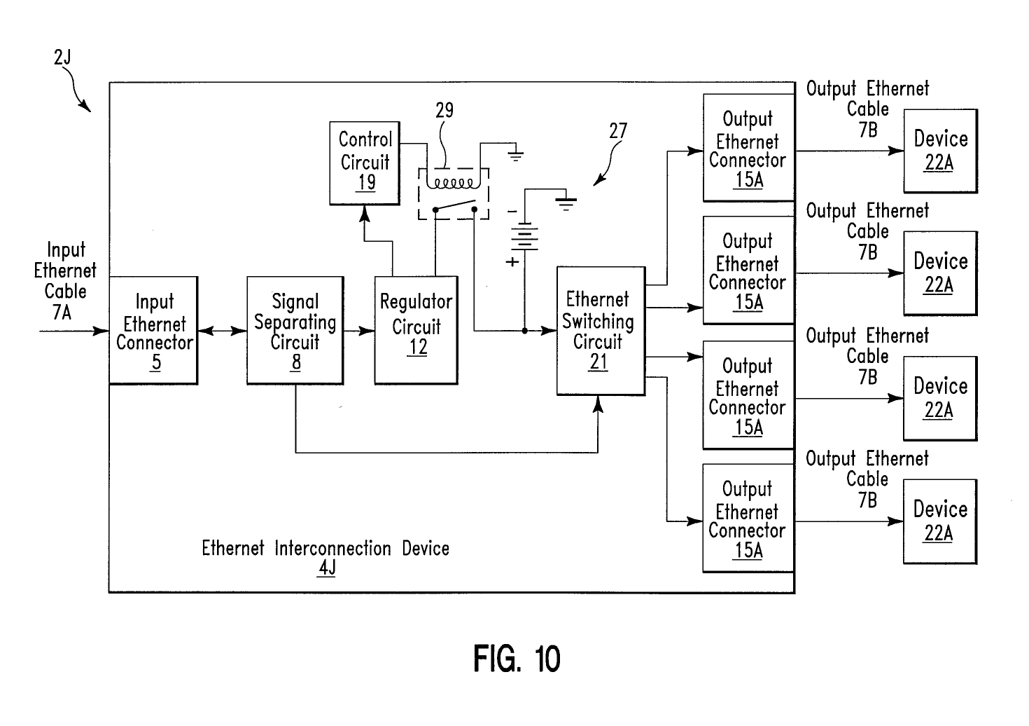

FIG. 10 illustrates a block diagram of a system 2J, in accordance with embodiments of the present invention. System 2J of FIG. 10 comprises an alternative to system 21 of FIG. 9. In contrast with Ethernet interconnection device 41 of FIG. 9, Ethernet interconnection device 4J of FIG. 10 comprises a normally closed interconnection device 29 (i.e., in place of diode D1) and a control circuit 19. Interconnection device 29 and control circuit 19 (i.e., in combination) of FIG. 4 replace and perform the functions of diode D1 of FIG. 9 (i.e., preventing a backflow of current from battery 27 to regulator circuit 12). Interconnection device 29 may comprise any type of interconnection device including, inter alia, a relay, etc. If control circuit 27 senses that regulator/conditioning circuit 12 is not providing an output voltage signal, control circuit 19 generates a control signal and transmits the control signal to interconnection device 29. In response, interconnection device 29 disables a circuit path between regulator circuit 12 and battery 17 thereby preventing a back flow of voltage from battery 27 to regulator circuit 12. Alternatively, system 2J of FIG. 10 may comprise battery 27 external to Ethernet interconnection device 4J.

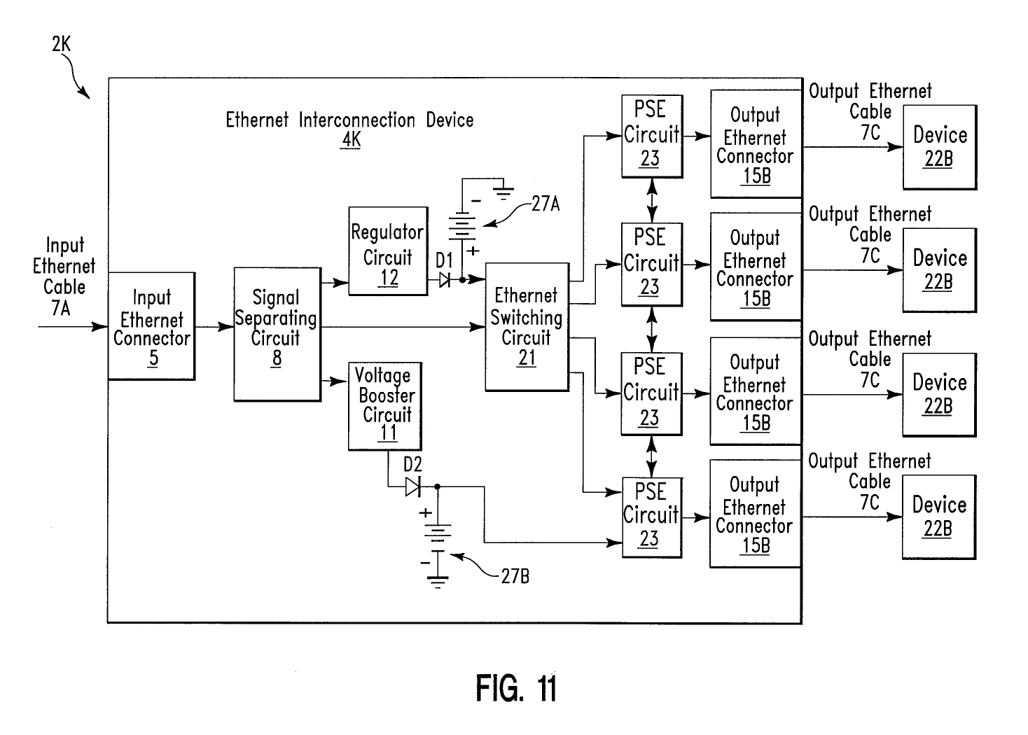

FIG. 11 illustrates a block diagram of a system 2K, in accordance with embodiments of the present invention. System 2K of FIG. 11 comprises an alternative to system 2H of FIG. 8. In contrast with Ethernet interconnection device 4H of FIG. 8, Ethernet interconnection device 4K of FIG. 11 comprises a diode D1 (e.g., a voltage directing circuit), a diode D2, a battery 27A (e.g., an electrical voltage storage device), and a battery 27B. Alternatively, Battery 27A and 27B may comprise any type of electrical voltage storage device including, inter alia, a capacitor. Battery 27A and 27B may comprise any type of rechargeable battery including, inter alia, lead acid, nickel metal hydride (NiMH), Alkaline, lithium ion, etc. In addition to conditioning a power signal (i.e., from Ethernet cable 7A) into a regulated voltage output signal for supplying power to Ethernet switching circuit 21, the regulated voltage output signal from regulator circuit 12 maintains or provides a charge for battery 27A. Charged battery 27A in combination with the regulated voltage output signal from regulator circuit 12 forms an uninterruptible power source (UPS) that will continue to supply power (i.e., voltage) to Ethernet switching circuit 21 if the power signal from Ethernet cable 7A is disabled. In the aforementioned scenario, battery 27 would continue to supply power to Ethernet switching circuit 21. For example, battery 27A may comprise a lead acid type of battery that may be charged by applying a fixed regulated voltage of 14.1 VDC (i.e., from regulator circuit 12). As battery 27A charges, a voltage on battery 27A floats up towards the fixed regulated voltage (i.e., 14.1 VDC) while reducing a current flow into battery 27A. In this example, a charge rate for battery 27A is regulated to prevent overcharging and damage to battery 27A. Diode D1 prevents a back flow of electrical current from battery 27A to regulator circuit 12 thereby preventing damage to regulator circuit 12. Battery 27A may be internal to Ethernet interconnection device 4K (i.e., part of and within Ethernet interconnection device 4K as illustrated in FIG. 11 or external to Ethernet interconnection device 4K. In addition to boosting a power signal from Ethernet cable 7A into boosted power signal (i.e., a higher voltage signal from the power signal from signal separating circuit 8) capable of powering industrial/commercial devices 22B, voltage booster circuit 11 additionally maintains or provides a charge for battery 27B. Charged battery 27B in combination with the boosted power signal from voltage booster circuit 11 forms an uninterruptible power source (UPS) that will continue to supply power (i.e., voltage) to PSE circuits 23 and ultimately to industrial/commercial devices 22B if the power signal from Ethernet cable 7A is disabled. In the aforementioned scenario, battery 27B would continue to supply power to PSE circuits 23 and industrial/commercial devices 22B. For example, battery 27B may comprise a lead acid type of battery that may be charged by applying a fixed regulated voltage of 14.1 VDC (i.e., from regulator circuit 12). As battery 27B charges, a voltage on battery 27B floats up towards the fixed regulated voltage (i.e., 14.1 VDC) while reducing a current flow into battery 27B. In this example, a charge rate for battery 27B is regulated to prevent overcharging and damage to battery 27B. Diode D2 prevents a back flow of electrical current from battery 27B to voltage booster circuit 12 thereby preventing damage to voltage booster circuit 12. Battery 27B may be internal to Ethernet interconnection device 4K (i.e., part of and within Ethernet interconnection device 4K as illustrated in FIG. 11) or external to Ethernet interconnection device 4K. Alternatively, Ethernet interconnection device 4K of FIG. 11 may comprise a first interconnection device and control circuit replacing and performing the functions of diode D1 and a second interconnection device and control circuit replacing and performing the functions of diode D2 as described with reference to FIG. 6.

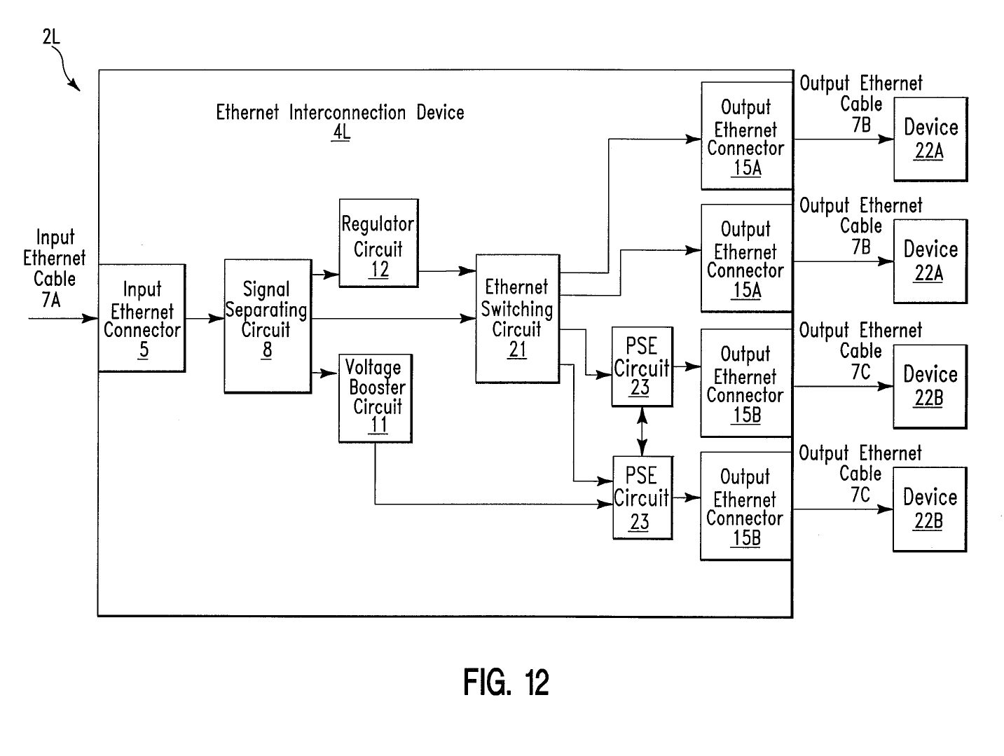

FIG. 12 illustrates a block diagram of a system 2L, in accordance with embodiments of the present invention. Ethernet interconnection device 4L of FIG. 12 comprises a combination of Ethernet interconnection device 4G of FIG. 7 and Ethernet interconnection device 4H of FIG. 8. Ethernet interconnection device 4L comprises an ability to retrieve the data signal from signal separating circuit 8 and selectively transmit the data signal though at least one of the plurality of Ethernet connectors 15A to at least one of devices 22A and/or generate a POE signal(s) and transmit the POE signal through an associated output Ethernet connector 15B to an associated industrial/commercial device 22B.

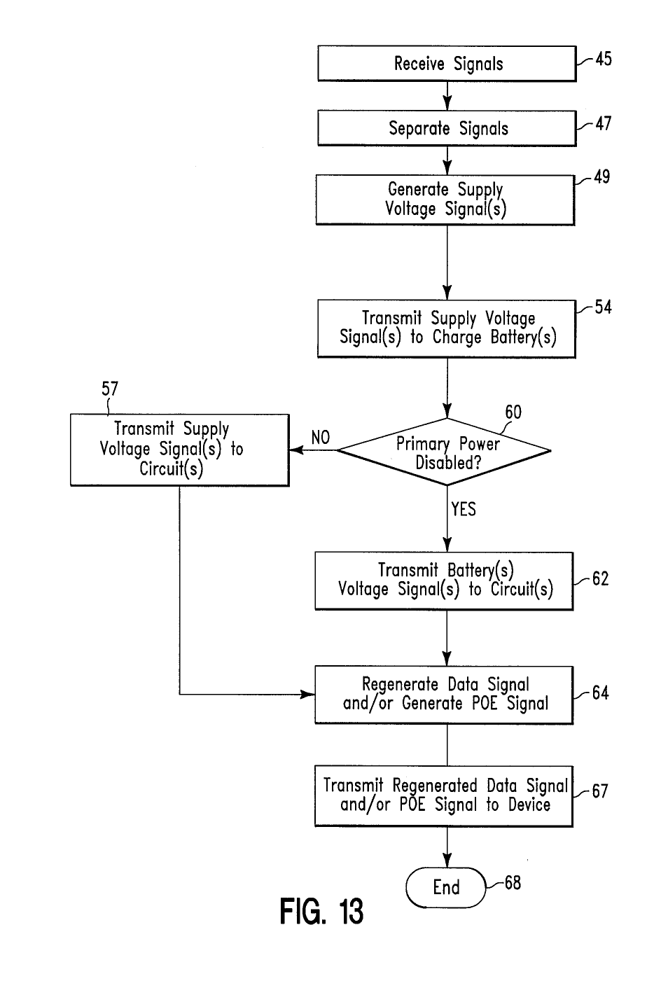

FIG. 13 illustrates a flowchart describing an algorithm used by systems 2A-2F of FIGS. 1-6, in accordance with embodiments of the present invention. In step 45, an Ethernet interconnection device (e.g., any of Ethernet interconnection devices 4A-4F of FIGS. 1-6) retrieves a data signal (e.g., I/O signals) and a power signal (e.g., power over Ethernet (POE)) from an Ethernet cable (e.g., Ethernet cable 7A of FIGS. 1-6). In step 47, a signal separating circuit (e.g., signal separating circuit 8) within the Ethernet interconnection device separates the data signal from the power signal. In step 49, the Ethernet interconnection device generates a regulated voltage output signal and/or a boosted voltage output signal from the power signal retrieved in step 45. The regulated voltage output signal is suitable for powering or supplying power for an Ethernet signal repeater circuit (e.g., Ethernet signal repeater circuit 14) and/or charging an electrical energy voltage storage device (e.g., a battery, a capacitor, etc). The boosted voltage output signal is suitable for powering or supplying power for an industrial/commercial device (e.g., industrial/commercial device(s) 22B) and/or charging an electrical energy voltage storage device (e.g., a battery, a capacitor, etc). In step 54, the regulated voltage output signal is optionally transmitted to charge a first electrical energy storage device (e.g., battery 27A) and the boosted voltage output signal is optionally transmitted to charge a second electrical energy storage device (e.g., battery 27B). In step 60, it is determined if the primary input power (i.e., power from the POE signal from input Ethernet cable 7A) has been disabled.

If in step 60, it is determined that the primary input power has not been disabled then in step 57, the regulated voltage output signal from the regulator circuit (e.g., regulator circuit 12) is transmitted to the Ethernet signal repeater circuit and the boosted voltage output signal is transmitted to a PSE circuit. In step 64, the data signal is regenerated and/or a POE signal is generated. In step 67, the regenerated data signal and/or the POE signal is transmitted to the industrial/commercial device(s) and the process terminates in step 68.

If in step 60, it is determined that the primary input power has been disabled then in step 62, the regulated voltage output signal from the first battery is transmitted to the Ethernet signal repeater circuit and the boosted voltage output signal from the second battery is transmitted to a PSE circuit. In step 64, the data signal is regenerated and/or a POE signal is generated. In step 67 the regenerated data signal and/or the POE signal is transmitted to the industrial/commercial device(s) and the process terminates in step 68.

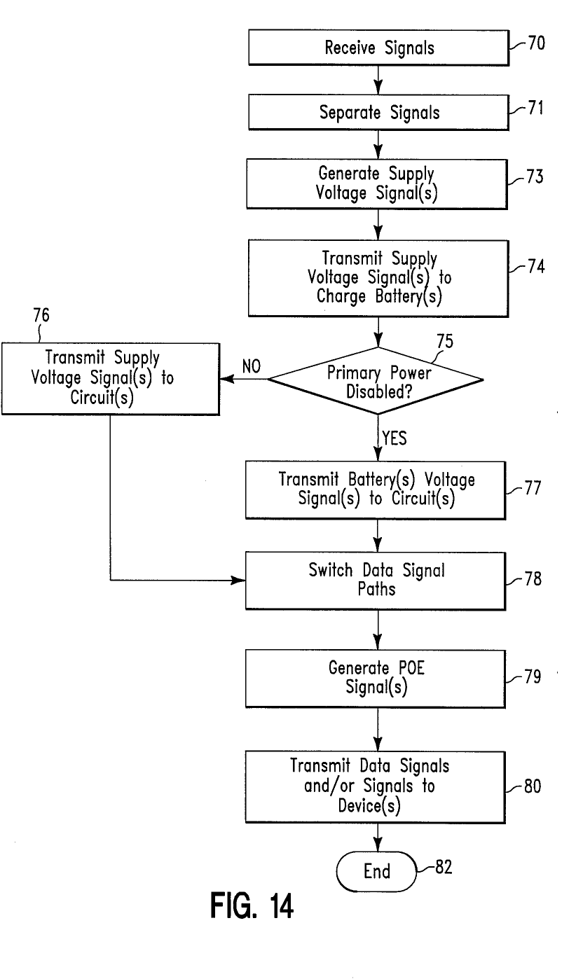

FIG. 14 illustrates a flowchart describing an algorithm used by systems 2G-2L of FIGS. 6-12, in accordance with embodiments of the present invention. In step 70, an Ethernet interconnection device (e.g., any of Ethernet interconnection devices 4G-4L of FIGS. 6-12) retrieves a data signal (e.g., I/O signals) and a power signal (e.g., power over Ethernet (POE)) from an Ethernet cable (e.g., Ethernet cable 7A of FIGS. 6-12). In step 71, a signal separating circuit (e.g., signal separating circuit 8) within the Ethernet interconnection device separates the data signal from the power signal. In step 73, the Ethernet interconnection device generates a regulated voltage output signal and/or a boosted voltage output signal from the power signal retrieved in step 70. The regulated voltage output signal is suitable for powering or supplying power for an Ethernet switching circuit (e.g., Ethernet switching circuit 21) and/or charging an electrical energy voltage storage device (e.g., a battery, a capacitor, etc). The boosted voltage output signal is suitable for powering or supplying power for an industrial/commercial device (e.g., industrial/commercial device(s) 22B) and/or charging an electrical energy voltage storage device (e.g., a battery, a capacitor, etc). In step 74, the regulated voltage output signal is optionally transmitted to charge a first electrical energy storage device (e.g., battery 27A) and the boosted voltage output signal is optionally transmitted to charge a second electrical energy storage device (e.g., battery 27B). In step 75, it is determined if the primary input power (i.e., power from the POE signal from input Ethernet cable 7A) has been disabled.

If in step 75, it is determined that the primary input power has not been disabled then in step 76, the regulated voltage output signal from the regulator circuit (e.g., regulator circuit 12) is transmitted to the Ethernet signal repeater circuit and the boosted voltage output signal is transmitted to a PSE circuit. In step 78, a path or paths for the data signal is selected. In step 79, a POE signal is optionally generated. In step 80, the data signal or the POE signal is transmitted over the path(s) selected in step 78 to the industrial/commercial device(s) and the process terminates in step 82.

If in step 75, it is determined that the primary input power has been disabled then in step 77, the regulated voltage output signal from the first battery is transmitted to the Ethernet signal repeater circuit and the boosted voltage output signal from the second battery is transmitted to a PSE circuit and step 78 is executed as described, supra.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. An Ethernet interconnection device comprising:
an input Ethernet connector configured to interface said Ethernet switch device to an Ethernet cable, wherein said input Ethernet connector is further configured to receive a first power over Ethernet (POE) signal from said Ethernet cable, and wherein said first POE signal comprises a first voltage signal and a first Ethernet data signal;
a signal separating circuit electrically connected to said input Ethernet connector, wherein said signal separating circuit is configured to receive said first POE signal from said input Ethernet connector and separate said first voltage signal from said first Ethernet data signal;
an Ethernet signal repeater circuit electrically connected to said signal separating circuit, wherein said Ethernet signal repeater circuit is configured to receive said first Ethernet data signal from said signal separating circuit and generate a regenerated Ethernet data signal from said first Ethernet data signal;
a voltage regulator circuit electrically connected to said signal separating circuit and said Ethernet signal repeater circuit, wherein said voltage regulator circuit is configured to receive said first voltage signal from said signal separating circuit and generate a second voltage signal from said first voltage signal, wherein said second voltage signal comprises a different voltage from said first voltage signal, and wherein said second voltage signal is a first power source for supplying power for said Ethernet signal repeater circuit; and
a first output Ethernet connector electrically connected to said Ethernet signal repeater circuit, wherein said first output Ethernet connector is configured to electrically conduct said regenerated Ethernet data signal to an industrial/commercial device.

2. The Ethernet interconnection device of claim 1, wherein said second voltage signal is further configured to charge an electrical energy storage device, wherein said electrical energy storage device is a second power source for supplying a third voltage signal to said Ethernet signal repeater circuit if said second voltage signal is disabled.

3. The Ethernet interconnection device of claim 2, wherein said Ethernet interconnection device comprises said electrical energy storage device.

4. The Ethernet interconnection device of claim 2, further comprising:
a voltage directing circuit configured to direct said third voltage signal to said Ethernet signal repeater circuit if said second voltage signal is disabled.

5. The Ethernet interconnection device of claim 4, wherein said voltage directing circuit is selected from the group consisting of a diode and a relay.

6. The Ethernet interconnection device of claim 2, wherein said electrical energy storage device comprises a battery.

7. The Ethernet interconnection device of claim 1, further comprising:
a voltage booster circuit electrically connected to said signal separating circuit, wherein said voltage booster circuit is configured to retrieve said first voltage signal from said signal separating circuit and generate a third voltage signal from said first voltage signal, wherein said third voltage comprises a different voltage from said first voltage signal and said second voltage signal; and
a power source equipment (PSE) circuit electrically connected to said voltage booster circuit and said Ethernet signal repeater circuit, wherein said first output Ethernet connector is electrically connected to said signal separating circuit through said PSE circuit, wherein said PSE circuit is configured to receive said regenerated Ethernet data signal from said Ethernet signal repeater circuit, receive said third voltage signal from said voltage booster circuit, and generate a second power over Ethernet (POE) signal from said regenerated Ethernet data signal and said third voltage signal, and wherein said first output Ethernet connector is further configured to electrically conduct said second POE signal to said industrial/commercial device.

8. The Ethernet interconnection device of claim 7, wherein said second voltage signal is further configured to charge a first electrical energy storage device, and wherein said first electrical energy storage device is a second power source for supplying a fourth voltage signal to said Ethernet repeater switching circuit if said second voltage signal is disabled.

9. The Ethernet interconnection device of claim 8, wherein said third voltage signal is further configured to charge a second electrical energy storage device, and wherein said second electrical energy storage device is configured as a third power source for providing a fifth voltage signal to said PSE circuit if said third voltage signal is disabled, wherein said PSE circuit is configured to generate a third power over Ethernet (POE) signal from said regenerated Ethernet data signal and said fifth voltage signal, and wherein said first output Ethernet connector is further configured to electrically conduct said third POE signal to said industrial/commercial device.

10. The Ethernet interconnection device of claim 9, wherein said Ethernet interconnection device comprises said first electrical energy storage device and said second electrical energy storage device.

11. The Ethernet interconnection device of claim 9, further comprising:
a first voltage directing circuit configured to direct said fourth voltage signal to said Ethernet signal repeater circuit if said second voltage signal is disabled; and
a second voltage directing circuit configured to direct said fifth voltage signal to said PSE circuit if said third voltage signal is disabled.

12. The Ethernet interconnection device of claim 11, wherein said first voltage directing circuit is selected from the group consisting of a diode and a relay, and wherein said second voltage directing circuit is selected from the group consisting of a diode and a relay.

13. The Ethernet interconnection device of claim 9, wherein said first electrical energy storage device comprises a battery, and wherein said second electrical energy storage device comprises a battery.

14. An electrical system comprising the Ethernet interconnection device of claim 9, the first electrical energy storage device, and the second electrical energy storage device, wherein the first electrical energy storage device is external to the Ethernet interconnection device, and wherein the second electrical energy storage device is external to the Ethernet interconnection device.

15. The Ethernet interconnection device of claim 1, wherein said second voltage signal exists at a voltage input for said Ethernet signal repeater circuit.

16. A method for forming the Ethernet interconnection device of claim 1, said method comprising electrically connecting said input Ethernet connector to said signal separating circuit, said voltage regulator circuit to said signal separating circuit, said Ethernet signal repeater circuit to said voltage regulator circuit, and said output Ethernet connector to said Ethernet signal repeater circuit such that said input Ethernet connector is connected to said signal separating circuit, said voltage regulator circuit is connected to said signal separating circuit, said Ethernet signal repeater circuit is connected to said voltage regulator circuit, said Ethernet signal repeater circuit is connected to said voltage regulator circuit, and said output Ethernet connector is connected to said Ethernet signal repeater circuit.

17. An Ethernet interconnection device comprising:
an input Ethernet connector configured to interface said Ethernet switch device to an Ethernet cable, wherein said input Ethernet connector is further configured to receive a first power over Ethernet (POE) signal from said Ethernet cable, and wherein said first POE signal comprises a first voltage signal and a first Ethernet data signal;
a signal separating circuit electrically connected to said input Ethernet connector, wherein said signal separating circuit is configured to receive said first POE signal from said input Ethernet connector and separate said first voltage signal from said first Ethernet data signal;
an Ethernet switching circuit electrically connected to said signal separating circuit;
a voltage regulator circuit electrically connected to said signal separating circuit and said Ethernet switching circuit, wherein said voltage regulator circuit is configured to receive said first voltage signal from said signal separating circuit and generate a second voltage signal from said first voltage signal, wherein said second voltage signal comprises a different voltage from said first voltage signal, and wherein said second voltage signal is a first power source for supplying power for said Ethernet switching circuit; and
a plurality of output Ethernet connectors electrically connected to said Ethernet switching circuit, wherein said Ethernet switching circuit is configured to receive said first Ethernet data signal from said signal separating circuit and selectively transmit said first Ethernet data signal to each output Ethernet connector of said plurality of output Ethernet connectors, and wherein said plurality of output Ethernet connectors are configured to electrically conduct said first Ethernet data signal to a plurality of industrial/commercial devices.

18. The Ethernet interconnection device of claim 17, wherein said second voltage signal is further configured to charge an electrical energy storage device, and wherein said electrical energy storage device is a second power source for supplying a third voltage signal to said Ethernet switching circuit if said second voltage signal is disabled.

19. The Ethernet interconnection device of claim 18, wherein said Ethernet interconnection device comprises said electrical energy storage device.

20. The Ethernet interconnection device of claim 18, further comprising:
a voltage directing circuit configured to direct said third voltage signal to said Ethernet switching circuit if said second voltage signal is disabled.

21. The Ethernet interconnection device of claim 20, wherein said voltage directing circuit is selected from the group consisting of a diode and a relay.

22. The Ethernet interconnection device of claim 18, wherein said electrical energy storage device comprises a battery.

23. The Ethernet interconnection device of claim 17, further comprising:
a voltage booster circuit electrically connected to said signal separating circuit, wherein said voltage booster circuit is configured to retrieve said first voltage signal from said signal separating circuit and generate a third voltage signal from said first voltage signal, wherein said third voltage comprises a different voltage from said first voltage signal and said second voltage signal; and
a plurality of power source equipment (PSE) circuits electrically connected to said voltage booster circuit and said Ethernet switching circuit, wherein each said output Ethernet connector is electrically connected to said signal separating circuit through an associated PSE circuit of said plurality of PSE circuits, wherein said plurality of PSE circuits are configured to generate a first plurality of power over Ethernet (POE) signals from said first Ethernet data signal and said third voltage signal, and wherein said plurality of output Ethernet connectors are further configured to electrically conduct said first plurality of POE signals to said plurality of industrial/commercial devices.

24. The Ethernet interconnection device of claim 23, wherein said second voltage signal further is configured to charge a first electrical energy storage device, and wherein said first electrical energy storage device is a second power source for supplying a fourth voltage signal to said Ethernet switching circuit if said second voltage signal is disabled.

25. The Ethernet interconnection device of claim 24, wherein said third voltage signal further is configured to charge a second electrical energy storage device, and wherein said second electrical energy storage device is a third power source for providing a fifth voltage signal to said plurality of PSE circuits if said third voltage signal is disabled, wherein said plurality of PSE circuits are configured to generate a second plurality of power over Ethernet (POE) signals from said first Ethernet data signal and said fifth voltage signal, and wherein said plurality of output Ethernet connectors are further configured to electrically conduct said second plurality of POE signals to said plurality of industrial/commercial devices.

26. The Ethernet interconnection device of claim 25, wherein said Ethernet interconnection device comprises said first electrical energy storage device and said second electrical energy storage device.

27. The Ethernet interconnection device of claim 25, further comprising:
a first voltage directing circuit configured to direct said fourth voltage signal to said Ethernet switching circuit if said second voltage signal is disabled; and
a second voltage directing circuit configured to direct said fifth voltage signal to said plurality of PSE circuits if said third voltage signal is disabled.

28. The Ethernet interconnection device of claim 27, wherein said first voltage directing circuit is selected from the group consisting of a diode and a relay, and wherein said second voltage directing circuit is selected from the group consisting of a diode and a relay.

29. The Ethernet interconnection device of claim 25, wherein said first electrical energy storage device comprises a battery, and wherein said second electrical energy storage device comprises a battery.

30. An electrical system comprising the Ethernet interconnection device of claim 25, the first electrical energy storage device, and the second electrical energy storage device, wherein the first electrical energy storage device is external to the Ethernet interconnection device, and wherein the second electrical energy storage device is external to the Ethernet interconnection device.

31. The Ethernet interconnection device of claim 17, wherein said second voltage signal exists at a supply voltage input for said Ethernet signal repeater circuit.

32. A method for forming the Ethernet interconnection device of claim 17, said method comprising electrically connecting said input Ethernet connector to said signal separating circuit, said voltage regulator circuit to said signal separating circuit, said Ethernet switching circuit to said voltage regulator circuit, and said plurality of output Ethernet connectors to said Ethernet switching circuit such that said input Ethernet connector is connected to said signal separating circuit, said voltage regulator circuit is connected to said signal separating circuit, said Ethernet switching circuit is connected to said voltage regulator circuit, and said plurality of output Ethernet connectors are connected to said Ethernet switching circuit.

33. A method comprising:
receiving, by an Ethernet interconnection device, a first power over Ethernet (POE) signal from an Ethernet cable, said first POE signal comprising a first voltage signal and a first Ethernet data signal, said Ethernet interconnection device comprising an input Ethernet connector connected to a signal separating circuit, a voltage regulator circuit connected to said signal separating circuit, an Ethernet signal repeater circuit connected to said voltage regulator circuit and said signal separating circuit, and output Ethernet connector connected to said Ethernet signal repeater circuit, said Ethernet interconnection device interfaced to said to said Ethernet cable by said input Ethernet connector;
receiving, by said signal separating circuit, said first POE signal from said Ethernet connector;
separating, by said signal separating circuit, said first voltage signal from said first Ethernet data signal;
receiving, by said Ethernet signal repeater circuit, said first Ethernet data signal from said signal separating circuit;
generating, by said Ethernet signal repeater circuit, a regenerated Ethernet data signal from said first Ethernet data signal;
receiving, by said voltage regulator circuit, said first voltage signal from said signal separating circuit; and
generating, by said voltage regulator circuit, a second voltage signal from said first voltage signal, wherein said second voltage signal comprises a different voltage from said first voltage signal, wherein said second voltage signal is a first power source for supplying power for said Ethernet signal repeater circuit, and wherein said first output Ethernet connector is configured to electrically conduct said regenerated Ethernet data signal to an industrial/commercial device.

34. The method of claim 33, further comprising:
charging, by said second voltage signal, an electrical energy storage device, wherein said second voltage signal has been disabled after said charging, and wherein said electrical energy storage device is a second power source for supplying a third voltage signal to said Ethernet signal repeater.

35. The method of claim 34, wherein said Ethernet interconnection device comprises said electrical energy storage device.

36. The method of claim 34, wherein said Ethernet interconnection device further comprises a voltage detecting circuit, and wherein said method further comprises:
directing, by said voltage directing circuit, said third voltage signal to said Ethernet signal repeater circuit.

37. The method of claim 36, wherein said voltage directing circuit is selected from the group consisting of a diode and a relay.

38. The method of claim 34, wherein said electrical energy storage device comprises a battery.

39. The method of claim 33, wherein said Ethernet interconnection device further comprises a voltage booster circuit electrically connected to said signal separating circuit and a power source equipment (PSE) circuit electrically connected to said voltage booster circuit and said Ethernet signal repeater circuit, wherein said first output Ethernet connector is electrically connected to said signal separating circuit through said PSE circuit, and wherein said method further comprises:
receiving, by said voltage booster circuit, said first voltage signal from said signal separating circuit;
generating, by said voltage booster circuit, a third voltage signal from said first voltage signal, wherein said third voltage comprises a different voltage from said first voltage signal and said second voltage signal;
receiving, by said PSE circuit, said regenerated Ethernet data signal and said third voltage signal;
generating, by said PSE circuit, a second POE signal from said regenerated Ethernet data signal and said third voltage signal, wherein said first output Ethernet connector is further configured to electrically conduct said second POE signal to said industrial/commercial device.

40. The method of claim 39, further comprising:
first charging, by said second voltage signal, a first electrical energy storage device, wherein said second voltage signal has been disabled after said first charging, and wherein said first electrical energy storage device is a second power source for supplying a fourth voltage signal to said Ethernet repeater switching circuit.

41. The method of claim 40, further comprising:
second charging, by said third voltage signal, a second electrical energy storage device, wherein said third voltage signal has been disabled after said second charging, wherein said second electrical energy storage device is a third power source for providing a fifth voltage signal to said PSE circuit, wherein said PSE circuit is configured to generate a third POE signal from said regenerated Ethernet data signal and said fifth voltage signal, and wherein said first output Ethernet connector is further configured to electrically conduct said third POE signal to said industrial/commercial device.

42. The method of claim 41, wherein said Ethernet interconnection device comprises said first electrical energy storage device and said second electrical energy storage device.

43. The method of claim 41, wherein said Ethernet interconnection device further comprises a first voltage directing circuit and a second voltage directing circuit, and wherein said method further comprises:
directing, by said first voltage directing circuit, said fourth voltage signal to said Ethernet signal repeater circuit; and
directing, by said second voltage directing circuit, said fifth voltage signal to said PSE circuit.

44. The method of claim 43, wherein said first voltage directing circuit is selected from the group consisting of a diode and a relay, and wherein said second voltage directing circuit is selected from the group consisting of a diode and a relay.

45. The Ethernet interconnection device of claim 41, wherein said first electrical energy storage device comprises a battery, and wherein said second electrical energy storage device comprises a battery.

46. The method of claim 33, wherein said second voltage signal exists at a supply voltage input for said Ethernet signal repeater circuit.

47. A method comprising:
receiving, by an Ethernet interconnection device, a first power over Ethernet (POE) signal from an Ethernet cable, said first POE signal comprising a first voltage signal and a first Ethernet data signal, said Ethernet interconnection device comprising an input Ethernet connector connected to a signal separating circuit, a voltage regulator circuit connected to said signal separating circuit, an Ethernet switching circuit connected to said voltage regulator circuit and said signal separating circuit, and a plurality of output Ethernet connectors connected to said Ethernet switching circuit, said Ethernet interconnection device interfaced to said to said Ethernet cable by said input Ethernet connector;
receiving, by said signal separating circuit, said first POE signal from said input Ethernet connector;
separating, by said signal separating circuit, said first voltage signal from said first Ethernet data signal;
receiving, by said Ethernet switching circuit, said first Ethernet data signal from said signal separating circuit;
generating, by said voltage regulator circuit, a second voltage signal from said first voltage signal, wherein said second voltage signal comprises a different voltage from said first voltage signal, and wherein said second voltage signal is a first power source for supplying power for said Ethernet switching circuit; and
selectively transmitting, by said Ethernet switching circuit, said first Ethernet data signal to each output Ethernet connector of said plurality of output Ethernet connectors, wherein said plurality of output Ethernet connectors are configured to electrically conduct said first Ethernet data signal to a plurality of industrial/commercial devices.

48. The method of claim 47, wherein said method further comprises:
charging, by said second voltage signal, an electrical energy storage device, wherein said second voltage signal has been disabled after said charging, and wherein said electrical energy storage device is a second power source for supplying a third voltage signal to said Ethernet switching circuit.

49. The method of claim 48, wherein said Ethernet interconnection device comprises said electrical energy storage device.

50. The method of claim 48, wherein said Ethernet interconnection device further comprises a voltage directing circuit, and wherein said method further comprises:
directing, by said voltage directing circuit, said third voltage signal to said Ethernet switching circuit.

51. The method of claim 50, wherein said voltage directing circuit is selected from the group consisting of a diode and a relay.

52. The method of claim 48, wherein said electrical energy storage device comprises a battery.

53. The method of claim 47, wherein said Ethernet interconnection device further comprises a voltage booster circuit electrically connected to said signal separating circuit and a plurality of power source equipment (PSE) circuits electrically connected to said voltage booster circuit and said Ethernet switching circuit, and wherein said method further comprises:
receiving, by said voltage booster circuit, said first voltage signal from said signal separating circuit;
generating, by said voltage booster circuit, a third voltage signal from said first voltage signal, wherein said third voltage comprises a different voltage from said first voltage signal and said second voltage signal;
receiving, by said plurality of PSE circuits, said regenerated Ethernet data signal and said third voltage signal; and
generating, by said plurality of PSE circuits, a first plurality of power over Ethernet (POE) signals from said first Ethernet data signal and said third voltage signal, wherein each said output Ethernet connector is electrically connected to said signal separating circuit through an associated PSE circuit of said plurality of PSE circuits, and wherein said plurality of output Ethernet connectors are further configured to electrically conduct said first plurality of POE signals to said plurality of industrial/commercial devices.

54. The method of claim 53, further comprising:
first charging, by said second voltage signal, a first electrical energy storage device, wherein said second voltage signal has been disabled after said first charging, wherein said first electrical energy storage device is a second power source for supplying a fourth voltage signal to said Ethernet switching circuit.

55. The method of claim 54, further comprising:
second charging, by said third voltage signal, a second electrical energy storage device, wherein said third voltage signal has been disabled after said second charging, wherein said second electrical energy storage device is a third power source for providing a fifth voltage signal to said plurality of PSE circuits, wherein said plurality of PSE circuits are configured to generate a second plurality of POE signals from said first Ethernet data signal and said fifth voltage signal, and wherein said plurality of output Ethernet connectors are further configured to electrically conduct said second plurality of POE signals to said plurality of industrial/commercial devices.

56. The method of claim 55, wherein said Ethernet interconnection device comprises said first electrical energy storage device and said second electrical energy storage device.

57. The method of claim 55, wherein said Ethernet interconnection device further comprises a first voltage directing circuit and a second voltage directing circuit, and wherein said method further comprises:
directing, by said first voltage directing circuit, said fourth voltage signal to said Ethernet switching circuit; and
directing, by said second voltage directing circuit, said fifth voltage signal to said plurality of PSE circuits.

58. The method of claim 57, wherein said first voltage directing circuit is selected from the group consisting of a diode and a relay, and wherein said second voltage directing circuit is selected from the group consisting of a diode and a relay.

59. The method of claim 55, wherein said first electrical energy storage device comprises a battery, and wherein said second electrical energy storage device comprises a battery.

60. The method of claim 47, wherein said second voltage signal exists at a supply voltage input for said Ethernet signal repeater circuit.
